(19) United States
(12) Patent Application Publication
(10) Pub. No.: US 2004/0172320 A1
(43) Pub. Date: Sep. 2, 2004

(54) Method and system for goal management

(75) Inventors: Peter Spellman, Arlington, MA (US); Shabbir Dahod, Andover, MA (US); Curtis Brown, Bedford, MA (US); Lucia Deus, Bedford, MA (US); Craig Leckband, Bedford, MA (US); John Kordash, Tyngsboro, MA (US); Michael Laux, Somerville, MA (US)

Correspondence Address: WILMER CUTLER PICKERING HALE AND DORR LLP, 60 STATE STREET, BOSTON, MA, 02109, US

(73) Assignee: Performaworks, Incorporated

(21) Appl. No.: 10/376,897

(22) Filed: Feb. 28, 2003

(51) Int. Cl. G06F 17/60

(52) U.S. Cl. 705/8

(57) ABSTRACT

A method and system are provided for managing goals of an organization. A goal tree is generated having a high level organization goal and one or more hierarchically organized subordinate goals aligned with the high level organization goal. Each goal is owned by one or more individuals associated with the organization. The goal tree is accessible to one or more of the individuals through a graphical user interface for their use in monitoring progress toward the goals.

### BACKGROUND OF THE INVENTION

1. Field of the Invention

The present invention relates generally to management of organizations and, more particularly, to goal management in organizations.

2. Description of Related Art

Organizations (such as, e.g., corporations and other business entities, government entities, military organizations, non-profit groups, and educational institutions) typically have various goals they seek to achieve. The term goal refers to an objective or initiative toward which an effort or endeavor is directed. For example, a business may have the goal of developing a new product or of reducing corporate expenses. These organization goals are typically decomposed into goals and tasks for particular individuals in the organization, who all thereby work toward achieving the organization goal.

While many organizations expend significant resources in developing organizational strategy and goals, they often have difficulty in achieving their goals because there is no easy to use mechanism for connecting individual employee work efforts with the strategic goals of the organization. This is particularly true for large, geographically dispersed organizations, for which it is especially difficult to communicate, track and manage goals of employees. It accordingly becomes difficult to ensure that individual employee goals and work efforts are focused or aligned with the needs of the organization.

A need exists for a goal management system that is easy to use and allows the goals and work efforts of individuals in an organization to be aligned with the goals of the organization.

### BRIEF SUMMARY OF EMBODIMENTS OF THE INVENTION

In accordance with one or more embodiments of the invention, a method is provided of managing goals of an organization. The method includes generating a goal tree having a high level organization goal and one or more hierarchically organized subordinate goals aligned with the high level organization goal. Each goal is owned by one or more individuals associated with the organization. The method also includes displaying the goal tree to one or more individuals through a graphical user interface for their use in monitoring progress toward the goals.

In accordance with one or more further embodiments of the invention, a goal management system is provided for managing goals of an organization. The system includes a computer having at least one processor, memory associated with the at least one processor and a program supported in the memory. The program contains instructions to generate a goal tree having a high level organization goal and one or more hierarchically organized subordinate goals aligned with the high level organization goal. Each goal is owned by one or more individuals associated with the organization. The program also includes instructions to display the goal tree to one or more of the individuals through a graphical user interface for enabling the individuals to monitor progress toward the goals.

In accordance with one or more further embodiments of the invention, a goal tree is provided for use in managing goals of an organization. The goal tree includes a high level organization goal and one or more hierarchically organized subordinate goals aligned with said high level organization goal. Each goal in the tree is owned by one or more individuals associated with the organization. The goal tree is accessible by one or more of the individuals through a graphical user interface for their use in monitoring progress toward the goals.

In accordance with one or more further embodiments of the invention, a computer program product in computer-readable media is provided for use in managing goals of an organization. The computer program product includes means for generating a goal tree having a high level organization goal and one or more hierarchically organized subordinate goals aligned with said high level organization goal. Each goal in the tree is owned by one or more individuals associated with the organization. The program product also includes means for displaying the goal tree to one or more of the individuals through a graphical user interface for monitoring progress toward the goals.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

FIG. 1 is a schematic block diagram of a network in which a goal management system in accordance with one or more embodiments of the invention can be implemented;

FIG. 2 is a screen shot of an exemplary organization hierarchy page generated by the goal management system;

FIG. 3 is a screen shot of an exemplary goal hierarchy page generated by the goal management system;

FIG. 4 is a screen shot of an exemplary goal details page generated by the goal management system;

FIG. 5 is a screen shot of an exemplary current goals page generated by the goal management system;

FIG. 6 is a screen shot of an exemplary delete goal form generated by the goal management system;

FIG. 7 is a screen shot of an exemplary edit goal form generated by the goal management system;

FIG. 8 is a screen shot of an exemplary create goal form generated by the goal management system;

FIG. 9 is a screen shot of an exemplary create note form generated by the goal management system;

FIG. 10 is a screen shot of an exemplary create task form generated by the goal management system;

FIG. 11 is a screen shot of an exemplary reassign goal form generated by the goal management system; and

FIG. 12 is a screen shot of an exemplary update status form generated by the goal management system.

### DETAILED DESCRIPTION OF PREFERRED EMBODIMENTS

The present invention is generally directed to a method and system for managing goals within an organization. The term “organization” refers to an entity having a group of people (such as, e.g., personnel or employees) who work toward one or more goals or objectives.

The goal management system is particularly suited for use by organizations such as corporations and other business entities as illustrated in examples described herein. However, it should be understood that goal management systems in accordance with various embodiments of the invention can be used by a variety of other organizations including, but not limited to, government entities, military organizations, non-profit groups, and educational institutions.

Briefly, the goal management system improves an organization's ability to execute organization strategy and achieve objectives by aligning goals of persons in the organization (and thereby the work efforts) to high-level organization goals.

The goal management system can be used to generate a goal tree (i.e., a goal hierarchy) preferably based generally on the organizational hierarchy (i.e., the hierarchy of personnel in the organization). In the goal tree, high-level organization goals are decomposed into particular goals for personnel at various levels in the organizational hierarchy. (As used herein, the terms personnel, employees and users refer to persons at all levels in the organizational hierarchy including, e.g., managers and subordinates.) More specifically, the high-level organization goals are decomposed into one or more subordinate goals aligned with the top-level goals. The subordinate goals are decomposed into one or more further subordinate goals. This is repeated until the high-level goal is cascaded through out the organizational hierarchy as needed. The goals in the goal tree are thereby all aligned to a top-level organizational goal, and personnel are assigned specific responsibilities aligned to the high-level goal. The goal management system thereby connects organization strategy to execution by aligning goals at various levels in the organizational hierarchy. The goal management system thereby allows organization strategy to be communicated clearly and consistently, and organization goals become meaningful to all personnel.

The goal tree is preferably based generally on the organizational hierarchy. It should be noted that the goal tree need not strictly correspond to the organizational hierarchy. For example, the goal tree may skip one or more layers of the organizational hierarchy. In accordance with one or more alternate embodiments, the goal tree is generally independent of the organizational hierarchy.

The goal management system allows system users to view and monitor the goal tree through an easy-to-use graphical user interface, preferably a browser interface. Progress toward goals throughout the goal hierarchy can thereby be easily viewed and monitored. Management can be therefore be quickly alerted to any problems and can take corrective action such as, e.g., adding resources, adjusting strategy or reducing expenditures, before business plans or other strategic objectives are jeopardized.

The goal tree allows resources that are not aligned to the organization strategy to be easily identified. The resources can then be re-deployed where needed to achieve organization objectives. For example, managers and other personnel can add or modify goals, set new priorities and immediately cascade these changes throughout the goal tree. The changes made in the goal tree are controlled by a set of predetermined business rules. For example, if a goal is modified, all users with goals aligned to the modified goal are notified of the change and are asked to modify their goals to become realigned with the modified goal. Rapid communication of new goals allows employees to remain up to date, direct work efforts toward the most current organization goals, and receive immediate notification when course-corrections are needed.

The goal management system preferably periodically receives current data on the personnel hierarchy of the organization. Accordingly, as personnel changes are made in the organization, the goal tree can be automatically updated in accordance with predetermined business rules. For example, if a department in the organization is moved as part of a reorganization, the selected business rules could specify that the portion of the goal tree associated with the department be moved with the transferred employees. Alternatively, the rules could specify that the goals remain to be filled by new hires/transferees. As another example, the business rules might specify that if an employee is transferred to a new job, his or her goals remain in the position to be assumed by his or her replacement.

The goal management system preferably includes an access control feature, which selectively restricts the ability of system users to access the goals in the goal tree. It may be desirable to control which users are able to access which goals as some goals in the goal tree may contain, e.g., sensitive or proprietary information. The goal management system allows an access control list to be established for each goal (and other items such as tasks) in the goal tree. This list specifies which personnel have access to each goal. In particular, for each item, the access control list determines what users can access the item and what sort of access they have (e.g., read, write, modify, and delete). Thus, each item has an access control list that controls who can see the item and what they can do with it.

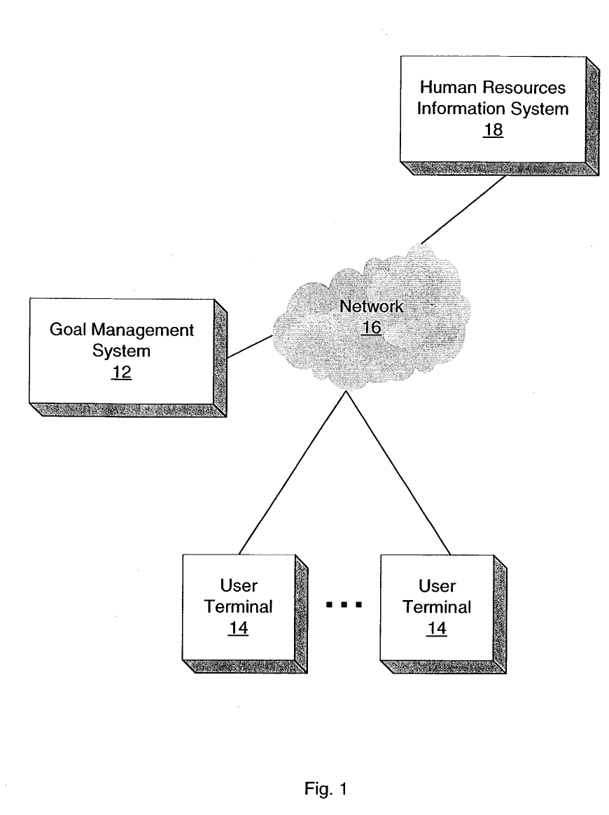

FIG. 1 schematically illustrates a representative network in which a goal management system 12 in accordance with one or more embodiments of the invention can be implemented. In general, the goal management system 12 includes a server system that communicates with a plurality of terminals or client devices 14 operated by system users (e.g., personnel or employees of the organization) over a network 16.

The network 16 can comprise a computer network such as, e.g., the Internet (particularly the World Wide Web), Intranets, LANs, WANs, MANs, or other networks, or some combination thereof. The server system of the goal management system 12 can be a Web server.

The client terminal devices 14 operated by users are typically personal computers such as, e.g., Pentium-based desktop or notebook computers running a Windows operating system. (Various other client terminal devices can also be used to communicate with the goal management system 12 including, e.g., personal digital assistants (PDAs), cell phones and other wired or wireless electronic devices.) As is well known, a representative personal computer includes a computer processing unit, memory, a keyboard, a pointing device such as a mouse or a touchpad, and a display unit. The screen of the display unit is used to present a graphical user interface (GUI) for the user. The GUI is supported by the operating system and allows the user to use a point and click method of input, e.g., by moving the mouse pointer on the display screen to an icon representing a data object at a particular location on the screen and pressing on the mouse buttons to perform a user command or selection. Also, one or more “windows” may be opened up on the screen independently or concurrently as desired.

The client terminals 14 typically include browsers, which are known software tools used to access Web servers. Representative browsers for personal computers include, among others, Netscape Navigator and Microsoft Internet Explorer.

A human resources information system 18 maintains current information on the personnel hierarchy of the organization. As personnel changes are made (e.g., personnel leave the organization, join the organization, or are promoted or reassigned within the organization), the human resources information system 18 updates the personnel hierarchy of the organization. The human resources information system 18 sends current data on the personnel hierarchy of the organization to the goal management system 12. The data can be sent, e.g., periodically (e.g., once a day) or whenever the hierarchy is updated.

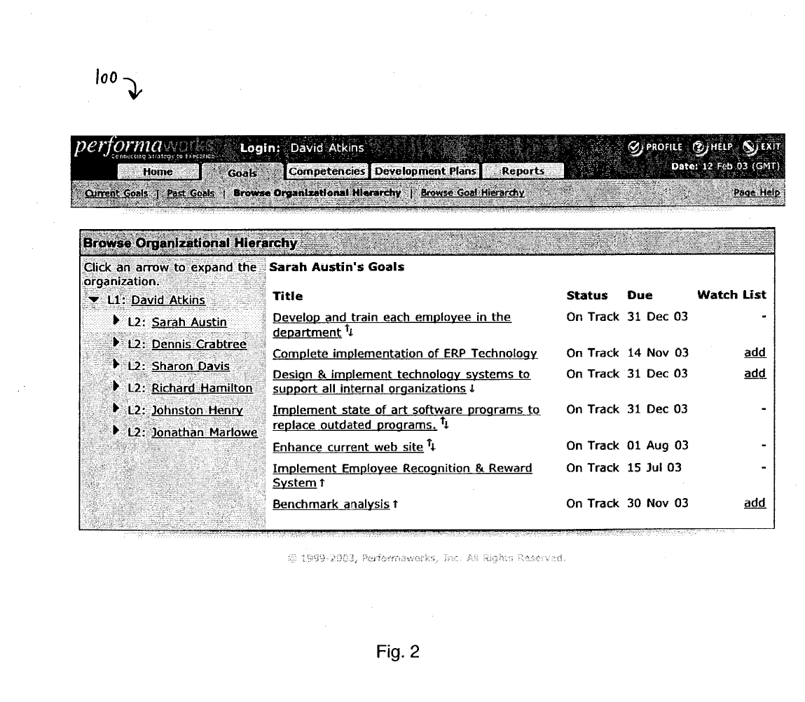

FIGS. 2-12 are screen shots of various exemplary pages that can be generated by the goal management system 12 for use in maintaining and monitoring a goal tree. System users can view these pages on their user terminals 14.

FIG. 2 is a representative screen shot illustrating a portion of an exemplary organizational hierarchy page 100 retrieved from the goal management system. The hierarchy shown includes a person at Level 1 or “L1” and persons subordinate to that person at L2. An arrow next to a person at L2 can be clicked to expand the hierarchy to show persons subordinate to that person, and so on. System users can thereby easily browse the organizational hierarchy. In addition, a user can also view the goals for each person in the organizational hierarchy. For example, in the FIG. 2 page 100, the goals of “Sarah Austin” are identified. However, access control rules are preferably established to control which users are able to view which goals of other personnel as some goals in the goal tree may, e.g., be sensitive or proprietary.

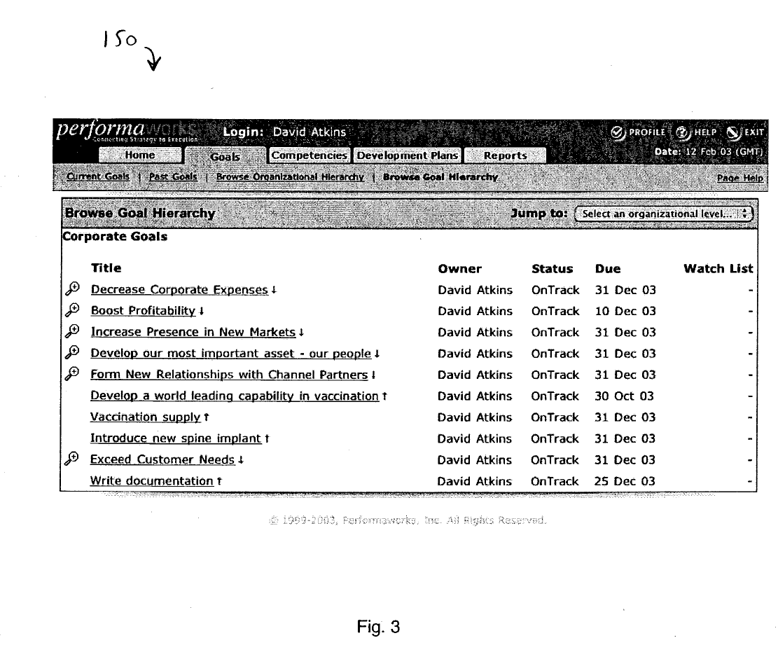

The goal management system also allows users to view the goal tree as shown, e.g., in FIG. 3, which is a screen shot of a portion of an exemplary goal tree 150. The goal tree identifies the hierarchy of goals for persons at various positions in the organizational hierarchy. In the FIG. 3 goal tree, a plurality of top-level corporate goals are shown. Goals that subordinate to the top-level goals can be viewed by expanding the top-level goals (by clicking on the expand symbol). The subordinate goals can also be expanded to show goals that are subordinate to those goals, and so on.

Users of the goal management system can thereby browse the entire goal tree (if authorized) to collect desired information on given goals, e.g., to identify the relationships between goals, the goal owner, the goal status and due date for goal completion. As used herein, an “owner” of a goal is the person associated with and responsible for achieving the goal.

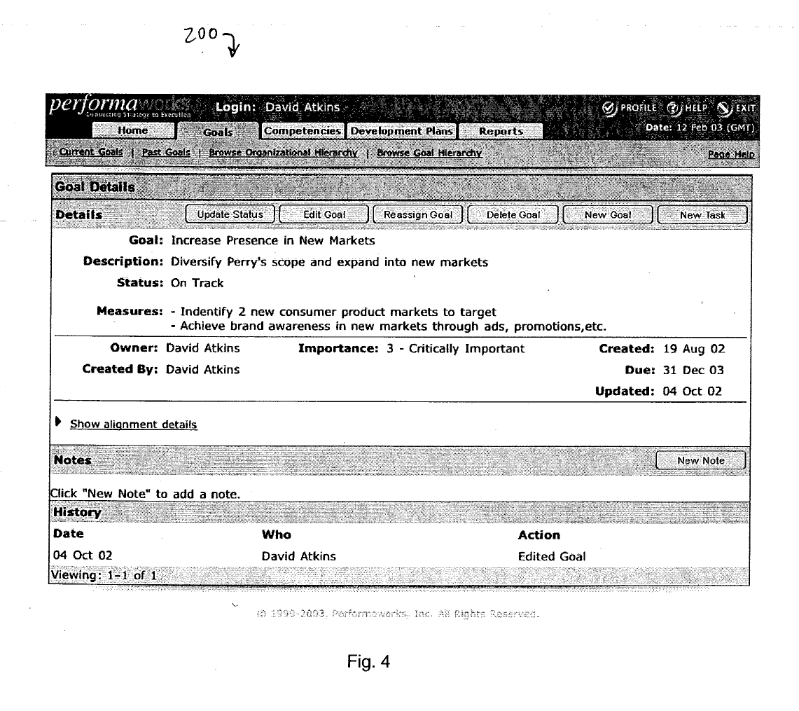

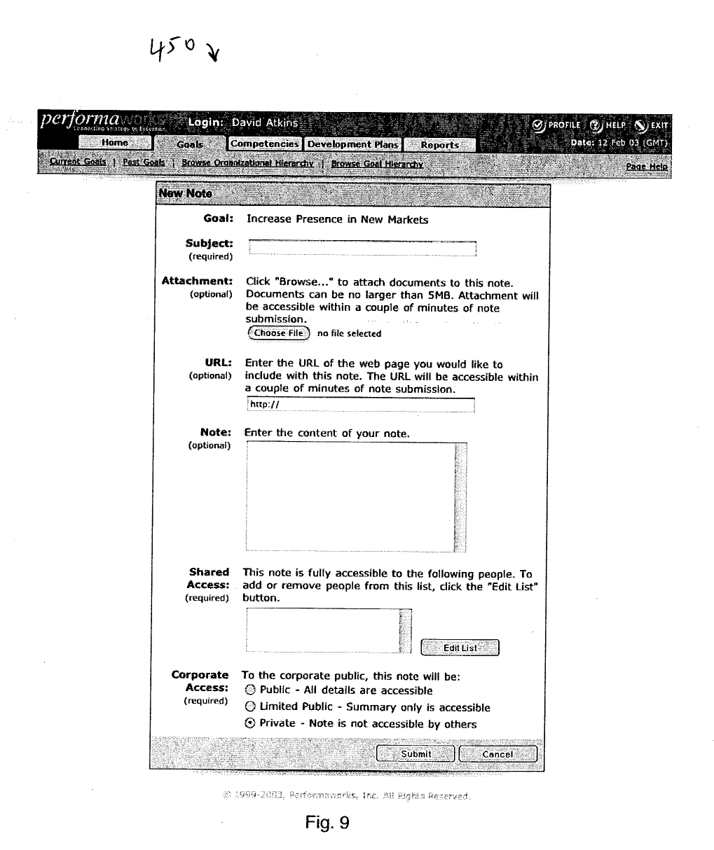

The details of a goal in the goal tree can be viewed on ‘goal details’ page 200, an exemplary screen shot of which is shown in FIG. 4. Users who have access to the goal can view information on the goal including, e.g., the goal title, description, owner, due date, create date, last modified date, importance level, status and the measures by which the goal will be judged. The goal “notes” (described below with respect to FIG. 9) and the status history for the goal can also be viewed in the goal details page.

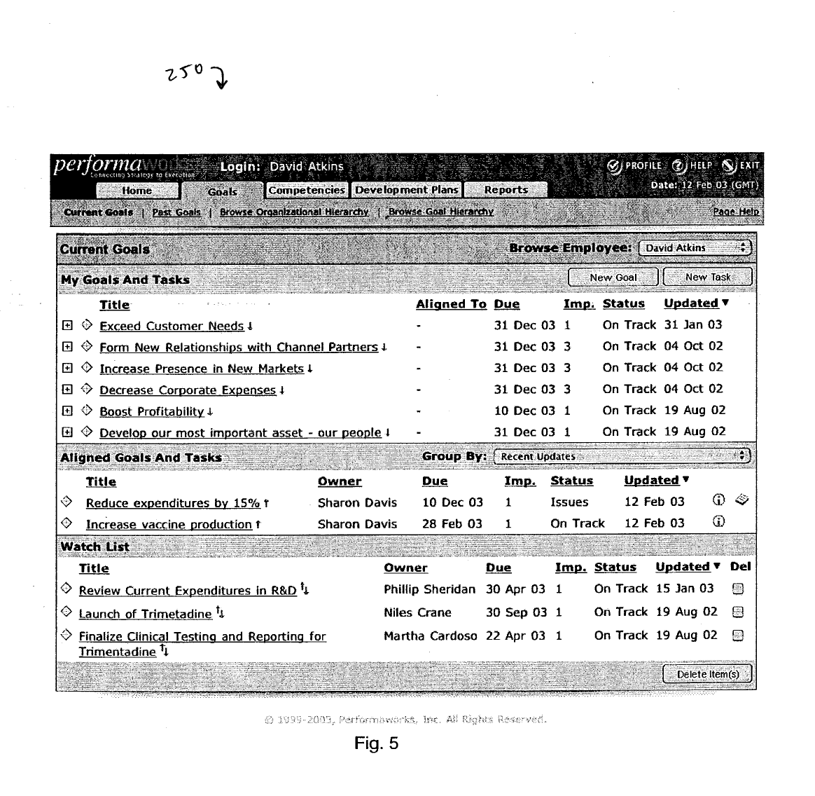

The goal management system can provide each user with a current goals page 250, an example of which is shown in FIG. 5. The upper area of the current goals page can identify the user's goals and tasks that are currently active, i.e., that have not yet been completed and removed from the tree. (Completed and other prior goals that are no longer active can be accessible in a past goals page (not shown).)

The middle area of the current goals page 250 can show select goals and tasks of other users that are aligned with one or more of the current goals. The middle area also preferably identifies the owners of those aligned goals and tasks.

The bottom area of the current goals page can be a ‘watch list’ area where a user can, if desired, monitor the progress of any selected goal in the goal tree that may be of interest to the user.

Users of the system who are authorized to do so can modify, delete or edit goals in the goal tree. Typically, owners and their managers are authorized to make these changes. However, any user can make these changes if specified in the access control list for the goal.

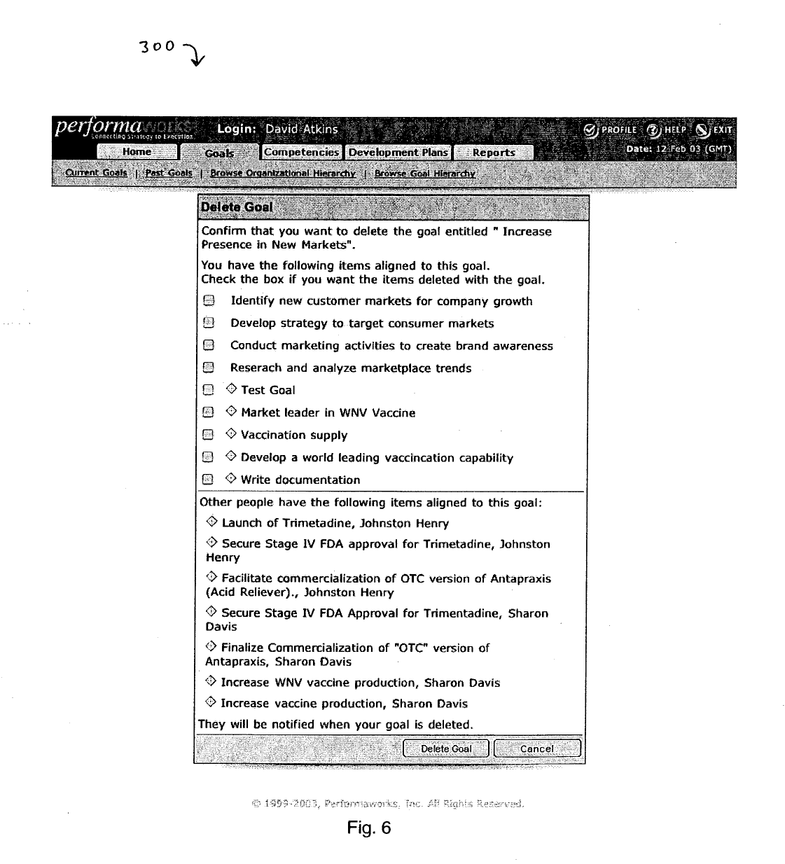

FIG. 6 is a screen shot of an exemplary “delete goal” page 300, which allows a user to delete a goal in the goal tree. The page 300 identifies all goals aligned to the goal to be deleted. If the goal at issue is deleted, the goal management system informs persons owning the aligned goals (e.g., by email) of the goal deletion. Owners of goals aligned to the deleted goal can then, e.g., delete aligned goals and tasks or realign the goals and tasks elsewhere in the tree.

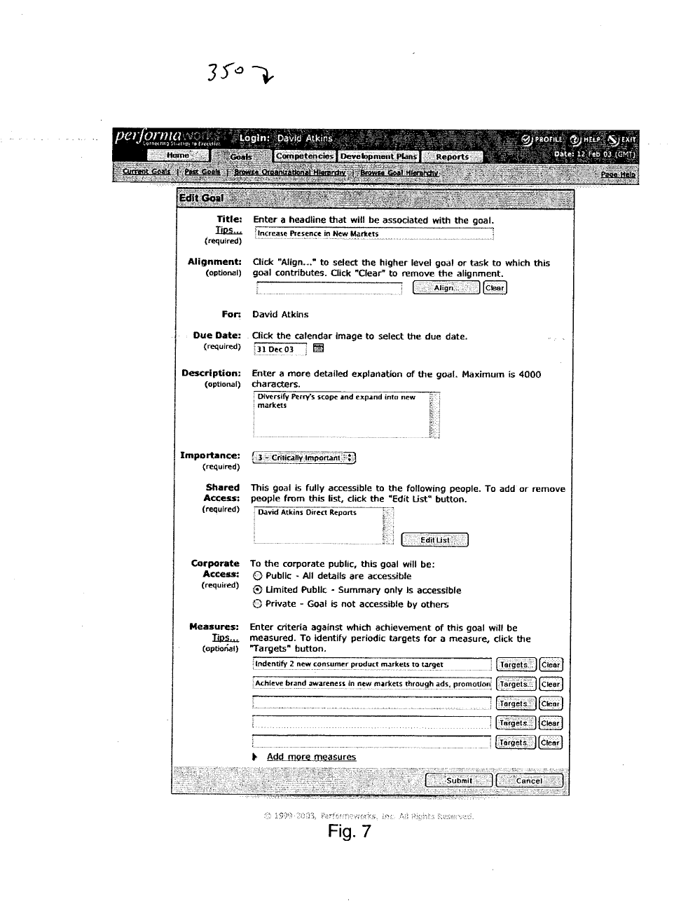

FIG. 7 is a screen shot of an exemplary “edit goal” form 350, which can be used to edit a goal in the goal tree. Various aspects of the goal can be edited including, e.g., the title, alignment, owner, due date, description, importance level, access restrictions, and measures.

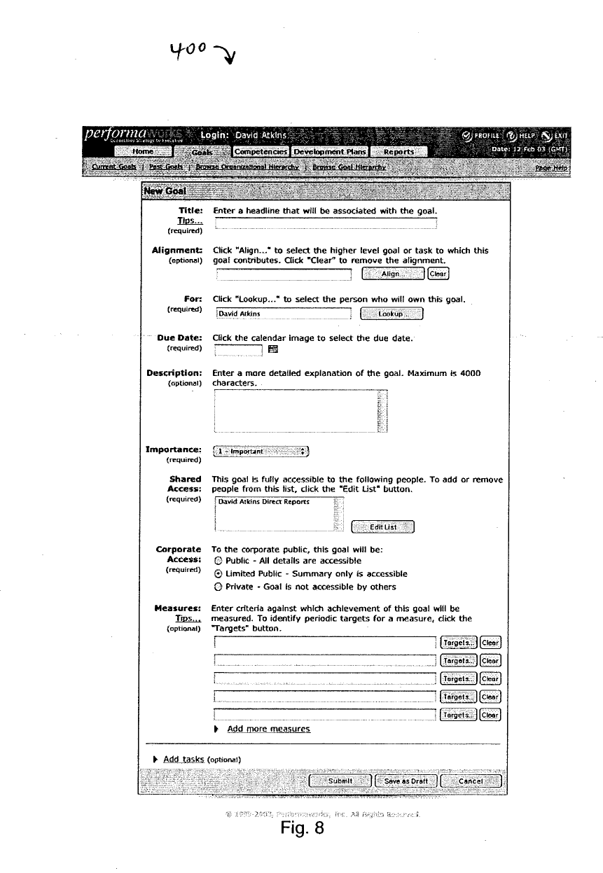

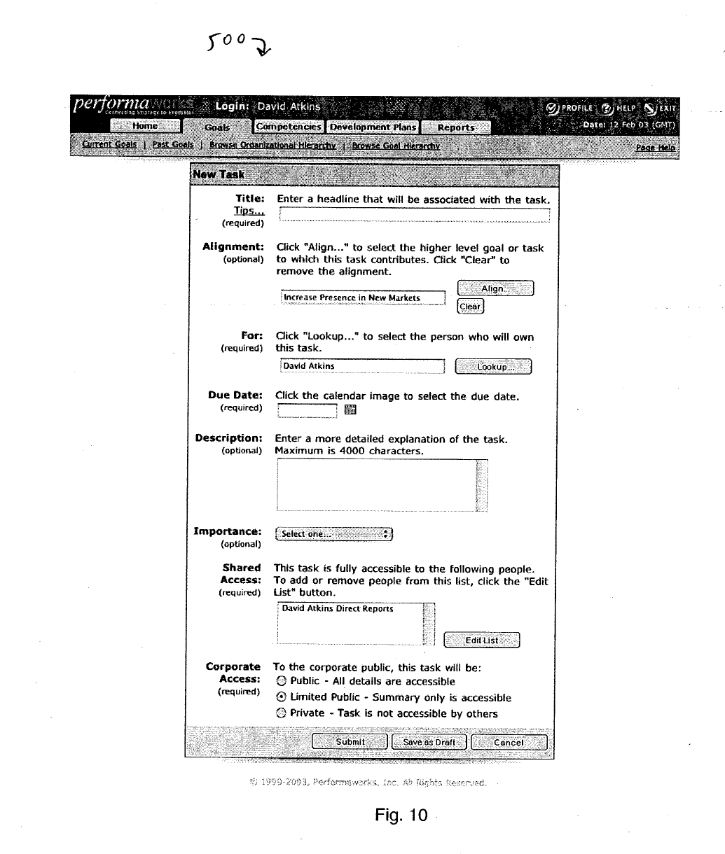

Goals can be created in a “new goal” form, a sample 400 of which is shown in FIG. 8. Fields in the form to be filled in can include title, alignment, owner, due date, description, importance, corporate and personal (shared) access control, and the measures, as well as targets by some period such as by quarter or month. It is also possible to add tasks for this goal through an “add tasks” link, which will be described below with respect to FIG. 10.

Users can attach ‘notes’ to goals. Notes can be used to convey additional information about a goal as well as to facilitate dialog on the goal. Examples of notes are status notes, where the status of the goal is indicated as well as explanatory text for the status. As an example, the note might state: “This goal is at risk because the supplier can't provide us with the chips on time.” Notes can also be used to facilitate dialog between users, e.g., between the goal owner and his or her manager. For example, the goal owner might state in the note that “this goal is almost ready, but you should increase the yield measure by 1%.” The manager might respond by stating in the note: “I increased the yield measure by 1% and in thinking about it also decided I needed to increase my procurement timeline by 30 days.”

Notes can contain URLs as well as document attachments. Notes can be access controlled and are typically accessed via the goal details page. Notes can be created using a “new note” form, a sample 450 of which is shown in FIG. 9. The new notes form 450 includes various fields that can be filled in including, e.g., subject or title, attachments, URL links, note details, and access control.

Tasks are items of work that contribute to goals. Tasks are associated with goals or other tasks that are associated with a goal. Tasks ordinarily have no measures. FIG. 10 is an exemplary form 500 that can be used to create a task. The form includes various fields that can be filled in by a user including, e.g., title, alignment, owner, due date, description, importance level, and access control.

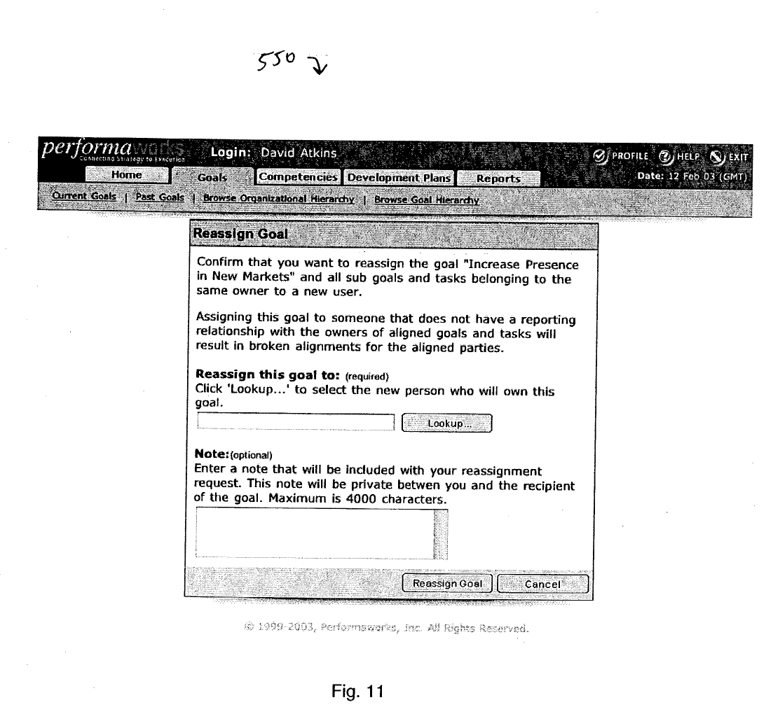

Goals in the goal tree can be reassigned as desired from one user to another. For example, it may be necessary or desirable to reassign tasks if an employee leaves to organization or if he or she is overworked. FIG. 11 is a screen shot of an exemplary form 550 that can be used to reassign a given goal.

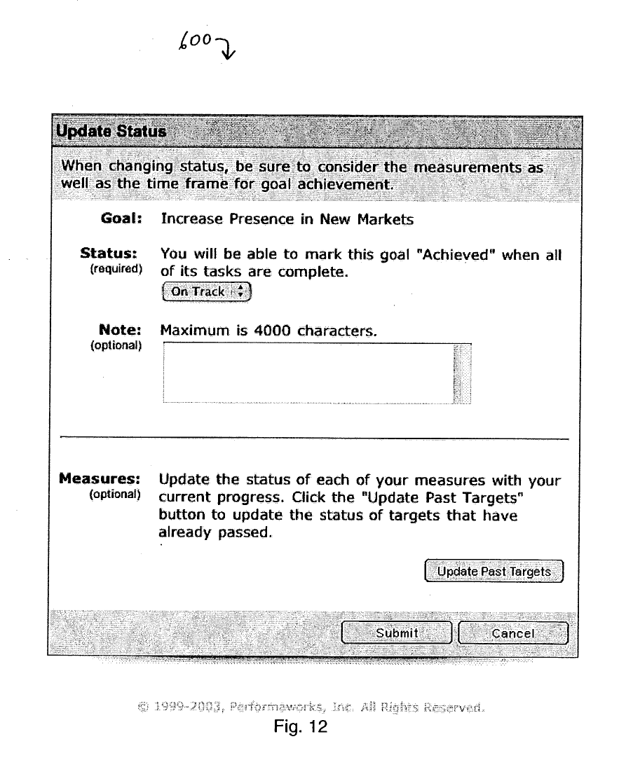

The status of a goal can be updated using a form such as the exemplary update status form 600 shown in FIG. 12. The update status form can be accessed through the goal details page (FIG. 4). It allows a user to state the current status of the goal and provide an explanation of the status and/or supply supporting documentation.

The functionality of the goal management system is preferably implemented in software, and accordingly one of the preferred implementations of the invention is as a set of instructions (program code) in a code module resident in the random access memory of the computer. Until required by the computer, the set of instructions may be stored in another computer memory, e.g., in a hard disk drive, or in a removable memory such as an optical disk (for eventual use in a CD ROM) or floppy disk (for eventual use in a floppy disk drive), or downloaded via the Internet or some other computer network. In addition, although the various functions described are conveniently implemented in a general purpose computer selectively activated or reconfigured by software, one of ordinary skill in the art would also recognize that such functions may be performed in hardware, in firmware, or in more specialized apparatus

Having described preferred embodiments of the present invention, it should be apparent that modifications can be made without departing from the spirit and scope of the invention.

1. A method of managing goals of an organization, comprising:
generating a goal tree having a high level organization goal and one or more hierarchically organized subordinate goals aligned with said high level organization goal, each goal owned by one or more individuals associated with said organization; and
displaying the goal tree to one or more of said individuals through a graphical user interface for use in monitoring progress toward said goals.

2. The method of claim 1 further comprising restricting access to said goals in the goal tree.

3. The method of claim 2 wherein said access is controlled by limitations specifying which of said individuals can access which of said goals.

4. The method of claim 1 further comprising receiving instructions for taking a corrective measure in response to detected problems in the progress toward said goals.

5. The method of claim 4 wherein said corrective measure includes adding, deleting or modifying one or more of said goals.

6. The method of claim 5 further comprising automatically cascading said corrective measure through said goal tree in accordance with one or more predetermined rules.

7. The method of claim 1 further comprising using an organizational hierarchy to generate the goal tree.

8. The method of claim 7 further comprising using an updated organizational hierarchy to modify the goal tree.

9. The method of claim 8 wherein the updated organizational hierarchy is received from a human resources information system.

10. The method of claim 1 wherein steps of said method are implemented in a computer.

11. The method of claim 1 wherein one or more of said individuals can access said goal tree online using a client terminal.

12. The method of claim 1 wherein each of said goals includes a description, status information, and owner information.

13. The method of claim 1 further comprising specifying one or more tasks associated with said goals.

14. The method of claim 1 further comprising updating the status of one or more of said goals.

15. A goal management system for managing goals of an organization, said system including a computer having at least one processor, memory associated with the at least one processor and a program supported in the memory containing instructions to:
generate a goal tree having a high level organization goal and one or more hierarchically organized subordinate goals aligned with said high level organization goal, each goal owned by one or more individuals associated with said organization; and
display the goal tree to one or more of said individuals through a graphical user interface for enabling the one or more individuals to monitor progress toward said goals.

16. The system of claim 15 further comprising instructions to restrict access to said goals in the goal tree.

17. The system of claim 16 wherein said access is controlled by limitations specifying which of said individuals can access which of said goals.

18. The system of claim 15 wherein the system receives instructions for taking a corrective measure in response to detected problems in the progress toward said goals.

19. The system of claim 18 wherein said corrective measure comprises adding, deleting or modifying one or more of said goals.

20. The system of claim 19 further comprising instructions for automatically cascading the corrective measure through said goal tree in accordance with one or more predetermined rules.

21. The system of claim 15 wherein instructions for generating a goal tree comprise instructions for generating a goal tree using an organizational hierarchy.

22. The system of claim 15 further comprising instructions for modifying the goal tree using an updated organizational hierarchy.

23. The system of claim 22 wherein the updated organizational hierarchy is received from a human resources information system linked to said system.

24. The system of claim 15 wherein said computer is a Web server.

25. The system of claim 15 wherein one or more of said individuals can access said goal tree online using a client terminal.

26. The system of claim 15 wherein each of said goals includes a description, status information, and owner information.

27. The system of claim 15 further comprising instructions for attaching one or more tasks associated with said goals.

28. A goal tree for use in managing goals of an organization, comprising:
a high level organization goal; and
one or more hierarchically organized subordinate goals aligned with said high level organization goal, each goal owned by one or more individuals associated with said organization;
said goal tree accessible by one or more of said individuals through a graphical user interface for monitoring progress toward said goals.

29. The goal tree of claim 28 wherein access to given goals in said goal tree is restricted.

30. The goal tree of claim 29 wherein said access is controlled by limitations specifying which of said individuals can access which of said goals.

31. The goal tree of claim 18 wherein goals can be added, deleted or modified in said goal tree.

32. The goal tree of claim 28 wherein changes to said goal tree are automatically cascaded through said goal tree in accordance with one or more predetermined rules.

33. The goal tree of claim 28 wherein said goal tree is generally based on a personnel hierarchy of the organization.

34. The goal tree of claim 28 wherein each of said goals includes a description, status information, and owner information.

35. The goal tree of claim 28 further comprising one or more tasks associated with said goals.

36. A computer program product in computer-readable media for use in managing goals of an organization, the computer program product comprising:
means for generating a goal tree having a high level organization goal and one or more hierarchically organized subordinate goals aligned with said high level organization goal, each goal owned by one or more individuals associated with said organization; and
means for displaying the goal tree to one or more of said individuals through a graphical user interface for monitoring progress toward said goals.

37. The computer program product of claim 36 further comprising means for restricting access to said goals in the goal tree.

38. The computer program product of claim 37 wherein said access is controlled by limitations specifying which of said individuals can access which of said goals.

39. The computer program product of claim 36 further comprising means for receiving instructions for taking a corrective measure in response to detected problems in the progress toward said goals.

40. The computer program product of claim 39 wherein said corrective measure comprises adding, deleting or modifying one or more of said goals.

41. The computer program product of claim 40 further comprising automatically cascading said corrective measure through said goal tree in accordance with one or more predetermined rules.

42. The computer program product of claim 36 wherein said goal tree is generated using an organizational hierarchy.

43. The computer program product of claim 42 further comprising means for using an updated organizational hierarchy to modify the goal tree.

44. The computer program product of claim 36 wherein each of said goals includes a description, status information, and owner information.

45. The computer program product of claim 36 further comprising means for updating the status of one or more of said goals.
